(19) United States
(12) Patent Application Publication
(10) Pub. No.: US 2018/0082346 A1
(43) Pub. Date: Mar. 22, 2018

(54) SYSTEM AND METHOD FOR AUTOMATIC PRODUCT DISTRIBUTION MANAGEMENT USING DISTRIBUTION NETWORK AND BIG DATA

(71) Applicants: NHN Entertainment Corporation, Seongnam-si (KR); NHN Studio629 Corporation, Seongnam-si (KR)

(72) Inventor: Chuljae LIM, Seongnam-si (KR)

(21) Appl. No.: 15/708,626

(22) Filed: Sep. 19, 2017

(30) Foreign Application Priority Data
Sep. 21, 2016 (KR) 10-2016-0120554

(51) Int. Cl. G06Q 30/06; G06F 17/30; G06Q 10/02; G06Q 30/02

(52) U.S. Cl. CPC G06Q 30/0623; G06F 17/30864; G06Q 30/0224; G06Q 10/02; G06Q 30/0641

(57) ABSTRACT

Provided is an automatic product distribution management system and method using a retailer distribution network and big data. The distribution management system may automatically construct a database that includes product information and discount information about an actual product sold in each retailer with respect to a distribution network that includes a plurality of retailers, and may provide, to a user terminal, a search result corresponding to a search query in response to the search query received from the user terminal, the search result retrieved from the database with respect to the retailer and at least one of the product information and the discount information.

### CROSS-REFERENCE TO RELATED APPLICATION

This application claims priority from and the benefit of Korean Patent Application No. 10-2016-0120554, filed on Sep. 21, 2016, which is hereby incorporated by reference for all purposes as if fully set forth herein.

### BACKGROUND OF THE INVENTION

### Field of the Invention

Exemplary embodiments relate to a product distribution management technology.

### Description of Related Art

In the modern society, many types of products are produced in large quantities by many producers. The produced products are sold through various types of retailers such as convenient stores, department stores, discount stores, chain stores, supermarkets, and grocery stores.

As an example of distribution management technology, Korean Patent Publication No. 10-2000-0036912, published on Jul. 5, 2000, discloses a one-stop market distribution information system that may provide information in which distribution information regarding a location and a benefit of a product that a user desires to purchase is sorted by region, company, product, and price.

### SUMMARY OF THE INVENTION

Exemplary embodiments provide an automatic product distribution management system and method using the distribution network and big data.

Additional features of the invention will be set forth in the description which follows, and in part will be apparent from the description, or may be learned by practice of the invention.

Exemplary embodiments disclose a computer-implemented automatic product distribution management method including: automatically constructing a database that includes product information and discount information about an actual product sold in each retailer with respect to a distribution network that includes a plurality of retailers; and providing, to a user terminal, a search result corresponding to a search query in response to the search query received from the user terminal, the search result retrieved from the database with respect to the retailer and at least one of the product information and the discount information.

The automatic construction of the database may include constructing the database by receiving the product information and the discount information from a terminal that is used at each retailer in the distribution network or by receiving the product information and the discount information for each retailer from a supplier server associated with the distribution network.

The discount information may include at least one of a discount policy offered from the retailer and a discount policy offered from a wholesale supplier that supplies a product to the retailer.

The providing may include providing the search result that includes a list of retailers selling a specific product and at least one of an inventory status and a discount benefit for each of the retailers selling the specific product, in response to the search query being associated with the specific product.

The providing may include providing the search result that includes a list of products registered as a discount target for each retailer, in response to the search query being a discount product inquiry request.

The providing may include providing the search result that is retrieved within a predetermined radius based on location information of the user terminal, in response to the location information being included in the search query.

The method may further include providing, to the user terminal, recommendation information about a product sold in the retailer.

The providing of the recommendation information may include providing, to the user terminal, the recommendation information about a product that is updated to the database.

The providing of the recommendation information may include providing, to the user terminal, a discount notification of a product corresponding to a discount target in response to the product corresponding to the discount target being registered to the database.

The providing of the recommendation information may include determining the recommendation information based on at least one of a product purchase pattern and a product preference of a user of the user terminal.

The method may further include processing a purchase reservation of a specific product in response to receiving a selection on the specific product among products sold in the retailer from the user terminal.

The processing may include providing a prepayment function; and transferring purchase reservation information about a prepaid product to a retailer specified by the user terminal, in response to processing a prepayment of the selected product through the prepayment function.

The method may further include collecting at least one user data of a search history and a purchase history associated with products sold in the retailer, and analyzing a product sales trend of the retailer.

The method may further include transferring an analysis result of the product sales trend to a terminal that is used at each retailer in the distribution network or a supplier server associated with the distribution server. The analysis result of the product sales trend may be used to determine a product distribution factor in the distribution network.

Exemplary embodiments also disclose a computer-implemented system for automatic product distribution management, the system including a memory to which at least one program is loaded; and at least one processor. The at least one processor includes an information manager configured to construct a database that includes product information and discount information about an actual product sold in each retailer with respect to a distribution network that includes a plurality of retailers; and a search result provider configured to provide, to a user terminal, a search result corresponding to a search query in response to the search query received from the user terminal, the search result retrieved from the database with respect to the retailer and at least one of the product information and the discount information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an exemplary network environment according to exemplary embodiments.

FIG. 2 illustrates an exemplary electronic device and an exemplary server according to exemplary embodiments.

FIG. 3 illustrates an exemplary distribution management environment according to exemplary embodiments.

FIGS. 4, 5, and 6 illustrate exemplary product distribution management services according to exemplary embodiments.

FIG. 7 illustrates an exemplary components of a processor of a server according to exemplary embodiments.

FIG. 8 is a flowchart illustrating an exemplary method performed at a server according to exemplary embodiments.

### DETAILED DESCRIPTION OF THE ILLUSTRATED EMBODIMENTS

Exemplary embodiments will be described in detail with reference to the accompanying drawings. These exemplary embodiments will be described in detail for those skilled in the art in order to practice the present disclosure. It should be appreciated that various exemplary embodiments are different but do not have to be exclusive. For example, specific shapes, configurations, and characteristics described in an exemplary embodiment may be implemented in another exemplary embodiment without departing from the spirit and the scope of the present disclosure. In addition, it should be understood that position and arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof

Hereinafter, exemplary embodiments are described in detail with reference to the accompanying drawings.

The exemplary embodiments relate to a product distribution management technology, and more particularly, to a system and method for providing an online product distribution service of a retailer.

The exemplary embodiments may disclose an online product distribution management of a retailer having improved efficiency, convenience, cost saving, and the like.

Herein, the term “retailer” used herein refers to an entity, such as a convenient store, a department store, a discount store, a chain store, a supermarket, a grocery market, and the like, for example, which distributes various types of products. Also, various products, such as industrial products, agricultural products, aquatic products, food, and the like, for example, may be distributed in the retailer. That is, the retailer may inclusively indicate any form of entity that distributes an arbitrary product by selling the product in response to a market demand.

Although the following description is made by using a convenient store as a representative example of the retailer, it is provided as an example only and the exemplary embodiments are not limited thereto.

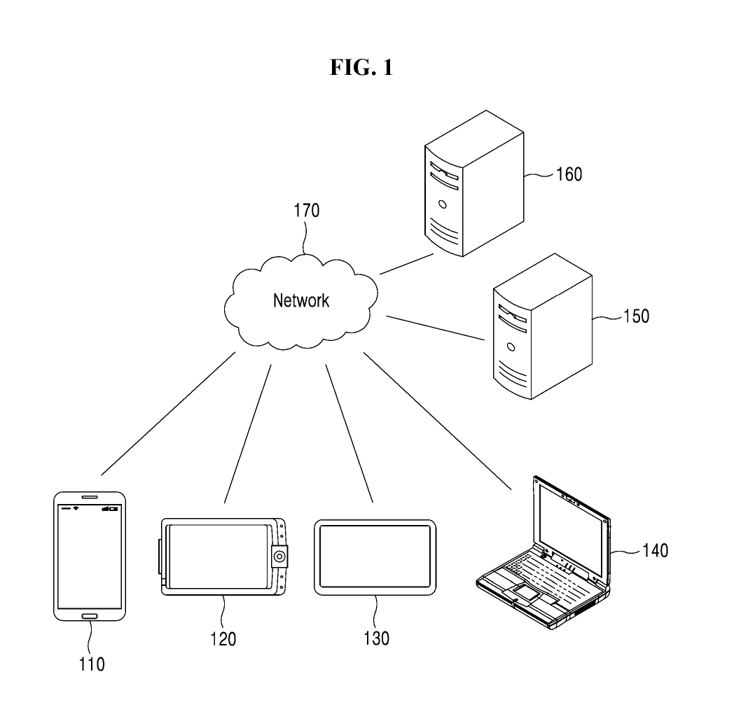

FIG. 1 illustrates an exemplary network environment according to exemplary embodiments. Referring to FIG. 1, the network environment includes a plurality of electronic devices 110, 120, 130, and 140, a plurality of servers 150 and 160, and a network 170. FIG. 1 is provided as an example only, and a number of electronic devices and/or a number of servers according to the exemplary embodiments are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, navigation, a computer, a laptop computer, a digital broadcasting terminal, a personal digital assistant (PDA), a portable multimedia player (PMP), a tablet personal computer (PC), and the like. For example, the electronic device 110 may communicate with other electronic devices 120, 130, and/or 140, and/or the servers 150 and/or 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network, which may be included in the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, it is only an example and the exemplary embodiments are not limited thereto.

Each of the servers 150 and 160 may be configured as a computer apparatus or a plurality of computer apparatuses that provides instructions, codes, files, contents, services, and the like, through communication with the plurality of electronic devices 110, 120, 130, and/or 140 over the network 170.

For example, the electronic device 110 may connect to the server 150 under control of at least one program, for example, a browser or a dedicated application, and an operating system (OS) included in the electronic device 110, and may receive a service or content provided from the server 150. For example, in response to a service request message that is transmitted from the electronic device 110 to the server 150 over the network 170 under control of the application, the server 150 may transmit a code corresponding to the service request message to the electronic device 110. The electronic device 110 may provide the content to the user by configuring and displaying a screen corresponding to the code under control of the application.

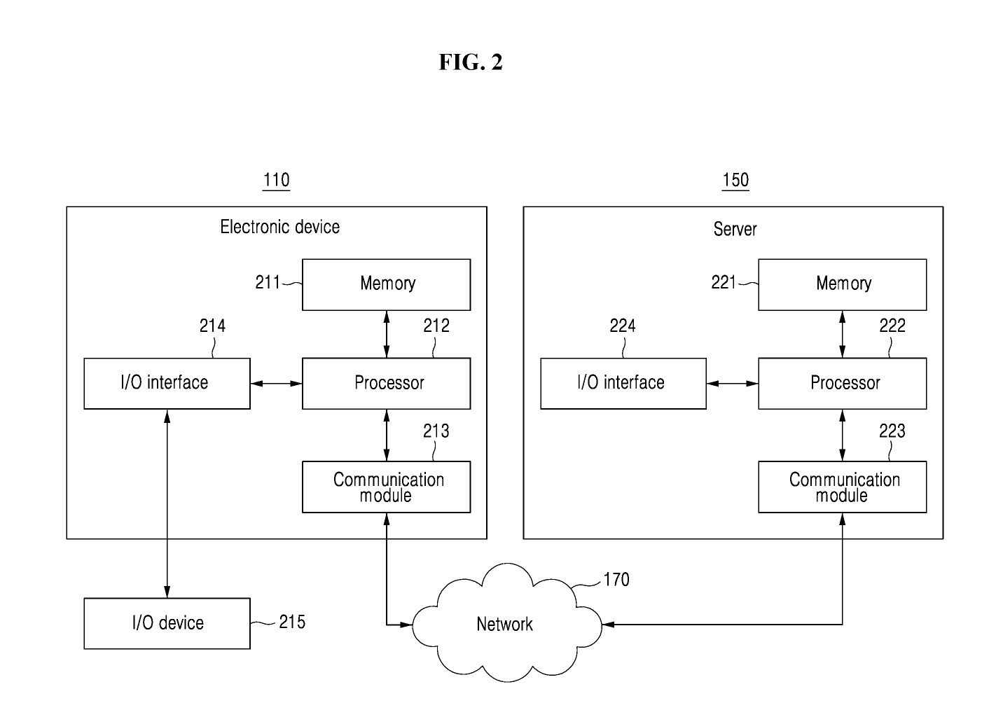

FIG. 2 illustrates an exemplary configuration of an electronic device and a server according to exemplary embodiments. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211 and 221 may include a permanent mass storage device, such as random access memory (RAM), read only memory (ROM), a disk drive, etc., as a computer-readable storage medium. Also, an OS and at least one program code, for example, a code for a browser or a dedicated application installed and executed on the electronic device 110, may be stored in the memory 211 and 221. Such software components may be loaded from another computer-readable storage medium separate from the memory 211 and 221. The other computer-readable storage medium may include, for example, a floppy drive, a disk, a tape, a DVD/CD-ROM drive, a memory card, etc. According to the exemplary embodiments, software components may be loaded to the memory 211 and 221 through the communication module 213 and 223, instead of, or in addition to, the computer-readable storage medium. For example, at least one program may be loaded to the memory 211 and 221 based on a program, for example, the dedicated application, installed by files provided over the network 170 from developers or a file distribution system (not shown) that provides an installation file of the application.

The processor 212 and 222 may be configured to process computer-readable instructions by performing basic arithmetic operations, logic operations, and I/O operations. The computer-readable instructions may be provided from the memory 211 and 221 and/or the communication module 213 and 223 to the processor 212 and 222. For example, the processor 212 and 222 may be configured to execute received instructions in response to the program code stored in the storage device, such as the memory 211 and 221.

The communication module 213 and 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, etc., of the server 150 received through the communication module 213 may be transferred to the processor 212 or the memory 211, and content, a file, etc., may be stored in a storage medium further includable in the electronic device 110.

The I/O interface 214 and 224 may be a device used for interface with an I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single function, such as a touch screen. In detail, when processing instructions of the computer program loaded to the memory 211, the processor 212 of the electronic device 110 may display a service screen configured using data provided from the server 150 or the electronic device 120, or may display content on a display through the I/O interface 214.

According to the exemplary embodiments, the electronic device 110 and the server 150 may include a greater or smaller number of components than the number of components shown in FIG. 2. However, there is no need to clearly illustrate many components according to the related art. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera, various physical buttons, a button using a touch panel, an I/O port, a vibrator for vibration, etc., which are generally included in the smartphone.

Hereinafter, exemplary embodiments of a system and method for a product distribution management service are described.

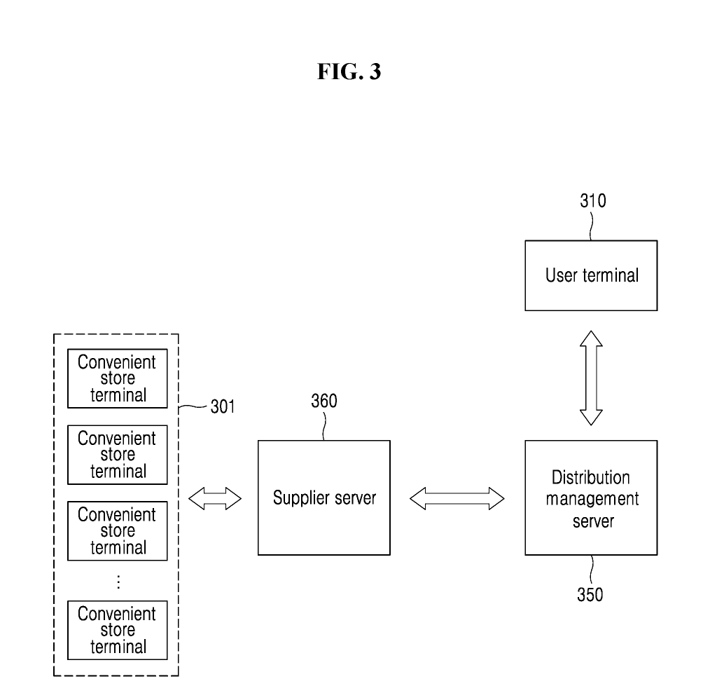

FIG. 3 illustrates an exemplary distribution management environment according to exemplary embodiments. Referring to FIG. 3, the distribution management environment includes a user terminal 310, a distribution management server 350, a supplier server 360, and a convenient store terminal 301. An indicator with arrowheads may indicate data transmitted and received between components over a wired network and/or a wireless network.

For example, the user terminal 310 may correspond to the electronic device 110 of FIG. 1, the distribution management server 350 may correspond to the server 150, and the supplier server 360 may correspond to the server 160.

The user terminal 310 indicates any type of terminal devices, for example, a PC, a smartphone, a tablet, etc., actually used by a user of a convenient store, capable of connecting to a website/mobile site associated with the distribution management server 350 or installing and executing a dedicated application. Here, the user terminal 310 may perform an overall service operation, such as a service screen configuration, a data input, a data transmission and reception, a data storage, and the like, under control of the website/mobile site or the dedicated application.

The distribution management server 350 may serve as a service platform to provide a product distribution management service. In particular, the distribution management server 350 may provide various types of information about a convenient store distribution network in response to a request of a user, and may provide a distribution management environment capable of applying and distributing actual products desired by the user with respect to a convenient store.

The supplier server 360 is a management server that is managed by a wholesale supplier that supplies products to convenient stores, and may collect, manage, and maintain location information, product information, discount information, etc., of all convenient stores to which the products are supplied.

The convenient store terminal 301 is a terminal device capable of connecting to a website/mobile site associated with the supplier server 360 or installing and executing a dedicated application, and may indicate an enterprise resource planning (ERP) terminal (including a point of sales (POS) terminal, etc.) associated with the supplier server 360.

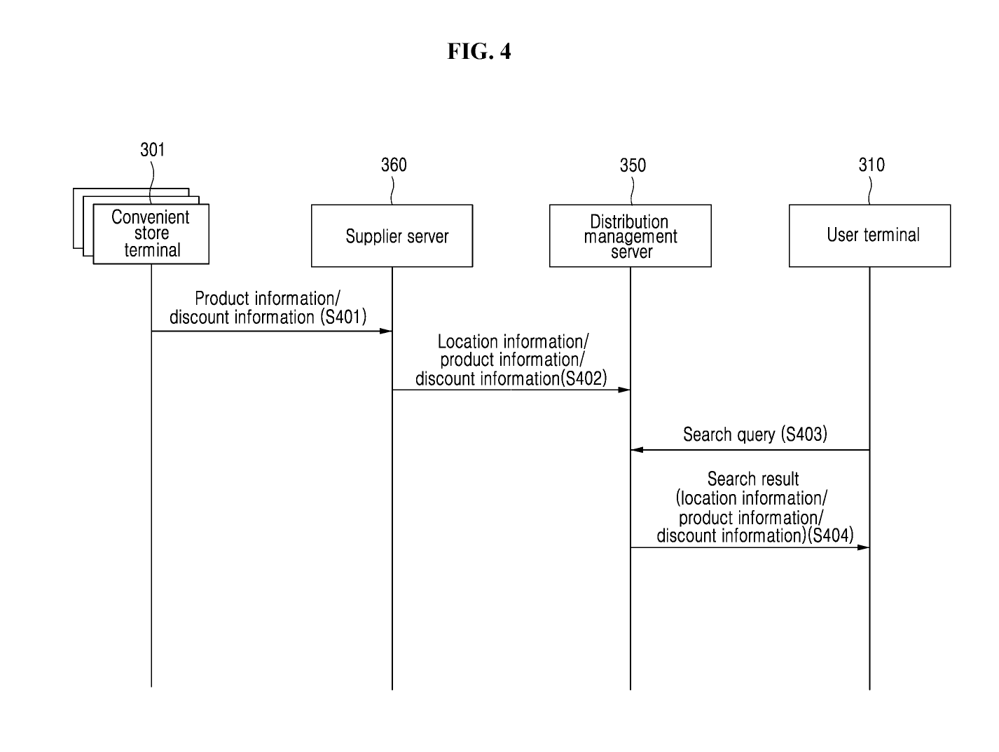

FIG. 4 illustrates an example of a product distribution management service according to exemplary embodiments.

Referring to FIG. 4, a convenient store orders a product desired to sell to a wholesale supplier using the convenient store terminal 301 and the wholesale supplier supplies the product ordered from convenient store terminal 301 to the corresponding convenient store through the supplier server 360.

The convenient store terminal 301 may manage and maintain overall information about the convenient store, for example, product information and discount information, and may transfer the product information and the discount information to the supplier server 360 at desired (or, alternatively predetermined) periods or point in time (S401). Here, the product information may include a list of products actually sold in the convenient store and an inventory status, and the like. The discount information may include, for example, discount contents used to run out products in stock of which expiration date is approaching. The product information and the discount information may be transferred to the supplier server 360 at desired (or, alternatively predetermined) periods, or may be transferred at an update point in time of information.

The supplier server 360 may automatically construct a database that include location information of each convenient store, product information, and discount information, and may transfer the corresponding information to the distribution management server 350 at desired (or, alternatively predetermined) periods or point in time (S402). Here, the location information may include address information of each convenient store, and the discount information may include discount contents transferred from the convenient store terminal 301 and promotion contents including benefits offered from the wholesale supplier, for example, buy one get one, buy one or get another, and the like. The supplier server 360 may collect product information and discount information of each convenient store and may transfer the collected product information and discount information to the distribution management server 350 with respect to convenient stores to which the wholesale supplier supplies products.

The distribution management server 350 may automatically construct the database based on the location information of each convenient store, the product information, and the discount information that are collected from the supplier server 360, and may automatically construct a service platform that includes a convenient store search portal and ordering system based on the database.

In response to a selection or an input of the user, the user terminal 310 may transfer a search query to the distribution management server 350 through a website/mobile site associated with the distribution management server 350 or a dedicated application (S403). Here, the search query may include location information of the user terminal 310.

The distribution management server 350 may provide, to the user terminal 310, a search result corresponding to the search query transferred from the user terminal 310 (S404). The search result may include at least one of location information, product information, and discount information in response to the search query. For example, in response to the user searching for a specific product, the distribution management server 350 may provide a list of convenient stores selling the specific product, an inventory status and discount benefits for each convenient store, and the like, as the search result. Here, the distribution management server 350 may provide the search result associated with at least one convenient store specified by the user terminal 310, for example, a convenient store preset by the user, a convenient store frequently used based on a purchase history of the user, and a convenient store present within a predetermined radius from a location of the user terminal 310 included in the search query. The distribution management server 350 may search for discount products for each convenient store and may provide the search result that includes a list of products corresponding to a discount target and discount contents for each product, for example, price, benefits, and the like. For example, once a convenient store registers a product of which expiration date is approaching as a discount product through the convenient store terminal 301, the distribution management server 350 may provide information about the convenient store and the product as a discount product inquiry result.

Accordingly, the distribution management server 350 may collect information, for example, products actually sold in each convenient store, a current inventory status, and discount benefits individually offered from each convenient store, discount benefits offered from the wholesale supplier, and the like, using a convenient store distribution network, and may provide a search portal service associated with convenient stores, and may provide the search result that includes an actual inventory status, discount benefits, and the like, of each convenient store.

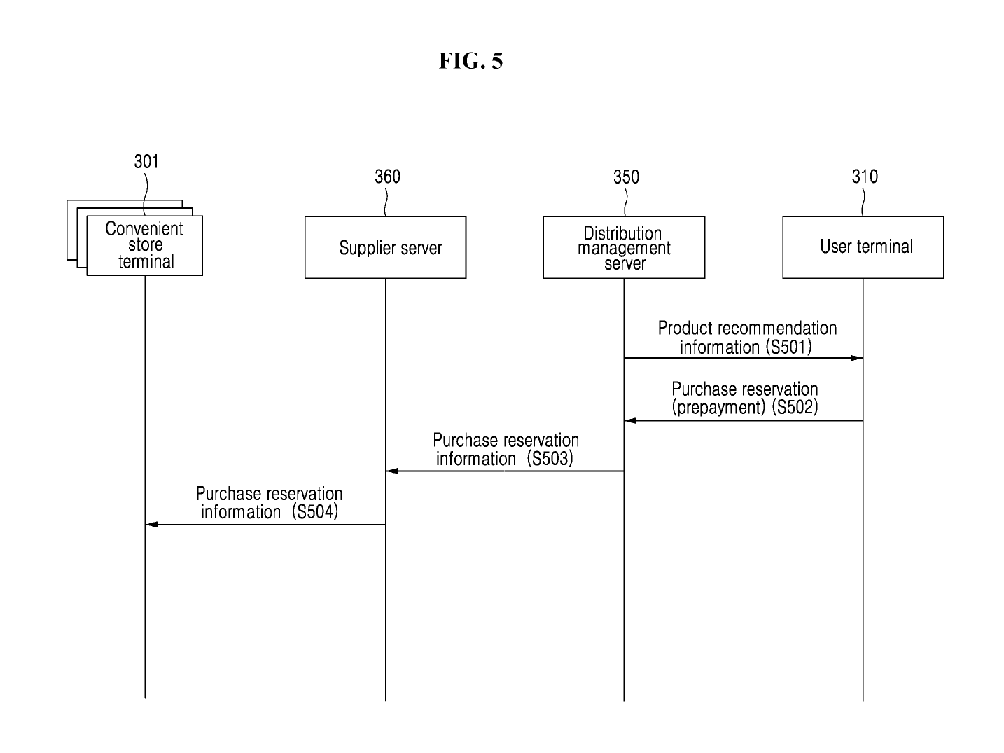

FIG. 5 illustrates another exemplary product distribution management service according to exemplary embodiments.

Referring to FIG. 5, the distribution management server 350 may automatically construct a database that includes location information of each convenient store, product information, and discount information using a convenient store distribution network, and may transfer recommendation information about products available at each convenient store to the user terminal 310 based on the database (S501). For example, the product information may include information about a new product newly released or sold. Once information about the new product is updated, the distribution management server 350 may provide recommendation information about the new product to the user terminal 310. As another example, once discount information of each convenient store is updated, the distribution management server 350 may provide recommendation information about a discount product to the user terminal 310. For example, once a convenient store registers a product of which expiration date is approaching as a discount product through the convenient store terminal 301, the distribution management server 350 may push a discount notification of the corresponding product to the user terminal 310. If the convenient store does not directly register a discount product based on the expiration date and expiration date information is included in product information, the convenient store terminal 301 may automatically register a product that is to be expired soon as the discount product based on the product information. As another example, if a product desired by the user is absent at a convenient store specified by the user terminal 310, the distribution management server 350 may provide recommendation information about a product similar to the desired product and/or recommendation information about other adjacent convenient stores having the desired product in stock. For example, if a convenient store A neither sells organic milk A nor has the same in stock while the user searches for the organic milk A among products of the convenient store A, the distribution management server 350 may recommend organic milk B similar to the organic milk A or may recommend another convenient store B in which the organic milk A is in stock.

Here, the distribution management server 350 may provide recommendation information about at least one convenient store specified by the user terminal 310, for example, a convenient store preset by the user, a convenient store frequently used based on a purchase history of the user, and a convenient store present within a predetermined radius from a location of the user terminal 310. Also, the distribution management server 350 may provide recommendation information about a product corresponding to a product preference or a purchase pattern through a tag, for example, a product name or type, preset by the user on the user terminal 310 or data analysis associated with the user.

The user terminal 310 may request a purchase reservation for the specific product through a website/mobile site associated with the distribution management server 350 or the dedicated application (S502). Here, the specific product may be a product that is selected by the user through a direct search or may be a product that is selected by the user from among recommended products. The distribution management server 350 may include a payment system on a product distribution management service platform, or may provide a prepayment service for products distributed in a convenient store in conjunction with the payment system automatically constructed as a separate system. For example, the distribution management server 350 may verify whether a product desired by the user is in stock at the convenient store specified by the user terminal 310, and may provide a preordering function if the product is out of stock. The user may request a purchase reservation of the product through a prepayment using the preordering function. Also, the distribution management server 350 may provide a list of convenient stores having the product desired by the user in stock. The user may select a convenient store and may request the purchase reservation of the product through the prepayment to secure the product before visiting the convenient store offline. Purchase reservation information corresponding to the purchase reservation request may include user information of the user that requests the purchase reservation, product purchase information about the product that the user desires to purchase, convenient store information about the convenient store that the user is to visit, and time information thereof.

The distribution management server 350 may transfer purchase reservation information of the user terminal 310 to the supplier server 360 (S503), and the supplier server 360 may transfer the purchase reservation information to the convenient store terminal 301 (S504). The convenient store terminal 301 may receive the purchase reservation information of the user from the distribution management server 350 through the supplier server 360, and may update an inventory status based on product purchase information included in the purchase reservation information. The convenient store may verify a prepaid product from the product purchase information included in the purchase reservation information, and may manage the corresponding product as the prepaid product if the product is in stock and, otherwise, may apply a corresponding status to ordering of the product. For example, the convenient store terminal 301 may verify a current inventory status of the prepaid product based on the product purchase information included in the purchase reservation information, and, if the prepaid product is out of stock, may generate order information of the product and may transfer the order information to the supplier server 360. Once the out-of-stock prepaid product becomes in stock, the convenient store terminal 301 may transfer a product-in-stock guide to the user terminal 310 of which the user has made the purchase reservation of the product through the supplier server 360 and the distribution management server 350.

Accordingly, the distribution management server 350 may configure various recommendation systems including a portal search with respect to products distributed in the convenient store, may induce the user to make a prepayment for a product in a product search environment or a product recommendation environment, and the like, and may provide a service that allows the user to secure the desired product in advance through the purchase reservation and the prepayment.

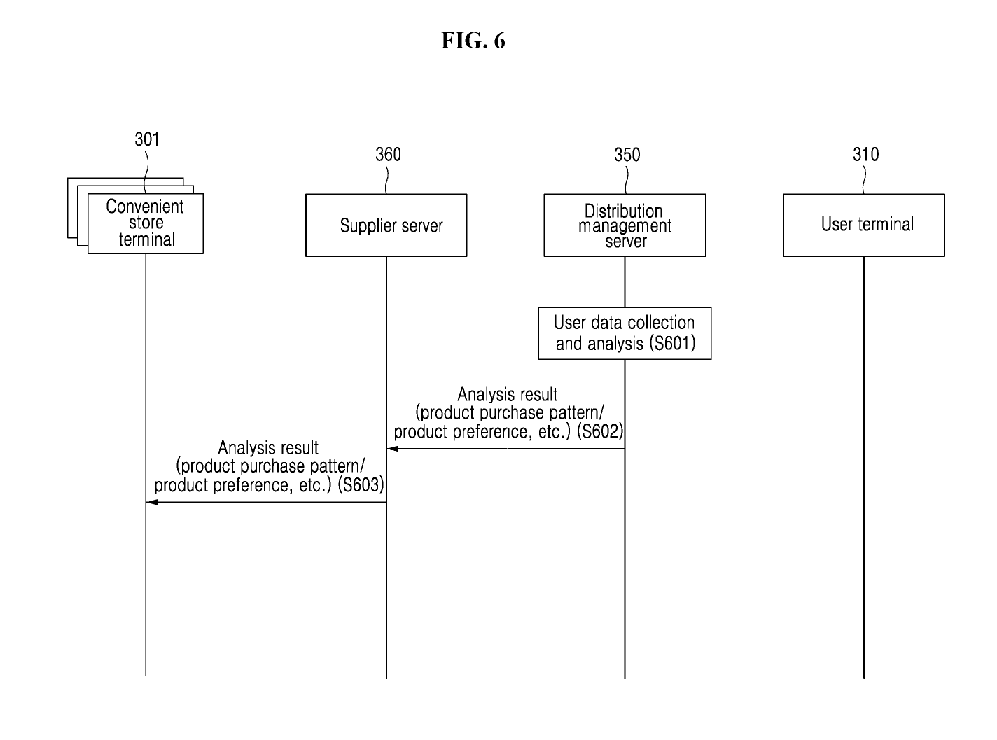

FIG. 6 illustrates another exemplary product distribution management service according to exemplary embodiments.

Referring to FIG. 6, the distribution management server 350 may collect and analyze user data with respect to products distributed in a convenient store (S601). Here, the user data may include a search history, a purchase history, and the like, with respect to products distributed in the convenient store. For example, the distribution management server 350 may analyze a product purchase pattern based on a purchase history of the user. As another example, the distribution management server 350 may analyze a product preference based on a search history and a purchase history of the user. That is, the distribution management server 350 may analyze a product sales trend of the convenient store by analyzing product purchase patterns or product preferences of users with respect to products distributed in the convenient store. Here, the distribution management server 350 may cluster user data using a corresponding convenient store for each convenient store and may analyze a product sales trend for each convenient store.

The distribution management server 350 may transfer an analysis result, for example, a product purchase pattern, a product preference, etc., of the user data to the supplier server 360 (S602). The supplier server 360 may use the analysis result transferred from the distribution management server 350 to determine a product distribution factor. The wholesale supplier may provide the overall information about a convenient store distribution network to the distribution management server 350 and, as feedback thereto, may receive a report about the product sales trend from the distribution management server 350. The wholesale supplier may determine a discount policy, a recommendation product, and the like, based on the product sales trend that is provided as the analysis result of the user data. For example, if convenient store A has a large amount of coffee sales, it is possible to increase a circulation amount of coffee-related products or to provide promotions for a coffee-related product such as offering a discount and the like, with respect to the convenient store A. If convenient store B has a large amount of lunch box sales, it is possible to increase a circulation amount of lunch box products or to provide promotions for a beverage, for example, milk, coffee, etc., available with the lunch box products.

The supplier server 360 may transfer the analysis result, for example, a product purchase pattern and a product preference, of the user data to the convenient store terminal 301 (S603). For example, the supplier server 360 may transfer a product sales trend that is an analysis result of each convenient store to each corresponding convenient store. For example, the supplier server 360 may provide the analysis result, for example, products that users of the convenient store A generally purchase, purchase patterns, purchase time, and the like, to the convenient store A. The convenient store terminal 301 may determine the analysis result transferred from the distribution management server 350 through the supplier server 360 to determine a product distribution factor. The convenient store may provide product information and discount information about products sold in the convenient store to the distribution management server 350 and, as feedback thereto, may receive a report about the product sales trend from the distribution management server 350. The convenient store may determine an ordering product, an order quantity, a discount policy, and the like, based on the product sales trend provided from the distribution management server 350.

As another example, the distribution management server 350 may also apply the analysis result of the user data to the aforementioned product recommendation logic. For example, the distribution management server 350 may recommend a coffee product in the morning and may recommend a late-night meal in the evening based on a product purchase pattern of the user, and may recommend products recently purchased by the user based on a product preference of the user. As another example, the distribution management server 350 may collect a user request, a user response, and the like for a convenient store distribution network and may transfer the collected user request, user response, and the like, to the supplier server 360. For example, the distribution management server 350 may collect a user request for a product desired to be sold or discounted at the convenient store or a user response to various types of surveys registered by the supplier server 360, and may transfer the collected information to the supplier server 360. The supplier server 360 may use the collected information provided from the distribution management server 350 to determine a product distribution factor.

Accordingly, the distribution management server 350 may collect the overall information about the convenient store distribution network and may provide a product distribution management service that includes a search portal and an ordering system with respect to the convenient store. Further, the distribution management server 350 may collect user data of users using the corresponding service and may analyze a product sales trend of the convenient store. The distribution management server 350 may feed back the product sales trend that is the analysis result of the user data to the supplier server 360 and/or the convenient store terminal 301, so that the wholesale supplier or the convenient store may apply the product sales trend to determine the product distribution factor.

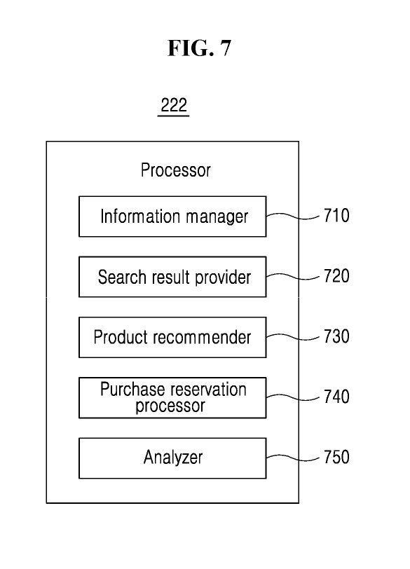

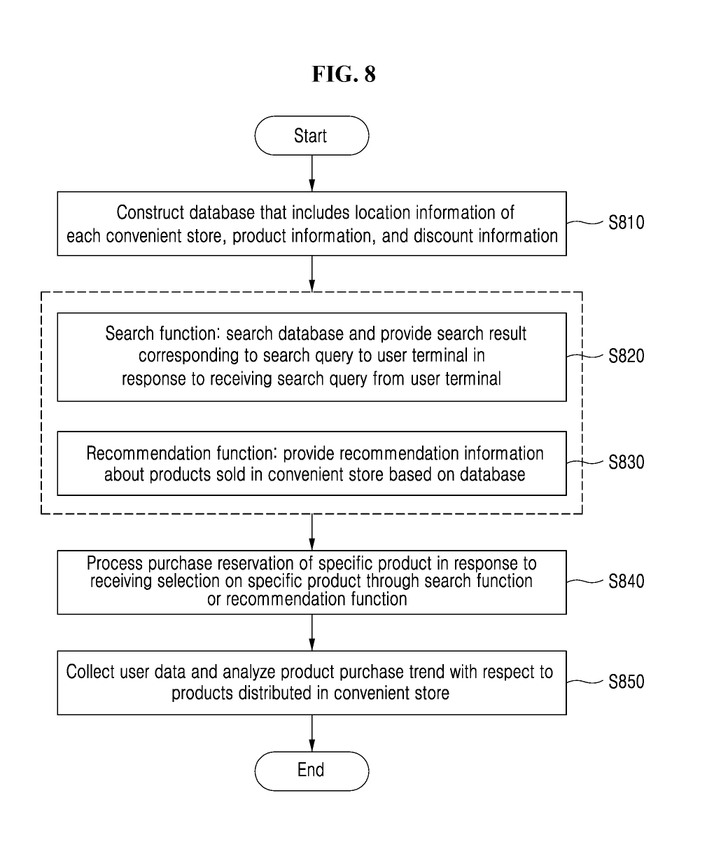

FIG. 7 illustrates an example of components includable in a processor of a distribution management server according to exemplary embodiments, and FIG. 8 is a flowchart illustrating an example of a template management process as a distribution management method according to exemplary embodiments.

Referring to FIG. 7, the processor 222 of the distribution management server 350 may include an information manager 710, a search result provider 720, a product recommender 730, a purchase reservation processor 740, and an analyzer 750 as components of the processor 222. The processor 222 and the components of the processor 222 may control the distribution management server 350 to perform operations S810 through S850 included in the distribution management method of FIG. 8. Here, the processor 222 and the components of the processor 222 may be configured to execute an instruction according to a code of at least one program and a code of the OS included in the memory 221. Also, the components of the processor 222 may be representations of different functions performed by the processor 222 in response to a control instruction provided from the OS or the at least one program. For example, the information manager 710 may be used as a functional expression that the processor 222 manages information associated with a convenient store distribution network in response to the control instruction.

Hereinafter, the following distribution management method may not be performed in illustrated order, and a portion of operations included in the distribution management method to may be omitted or an additional operation may be further included in the distribution management method.

Referring to FIG. 8, in operation S810, the information manager 710 may automatically construct and manage a database (hereinafter, a convenient store DB) that includes location information of each convenient store, product information, and discount information with respect to each convenient store included in a convenient store distribution network. For example, the information manager 710 may automatically construct the convenient store DB by receiving overall information of each convenient store from the supplier server 360 that is a management server of a wholesale supplier having the convenient store distribution network or by receiving overall information of each convenient store from the convenient store terminal 301 that is used at each corresponding convenient store. Here, the location information may include address information of a convenient store, and the product information may include a list of products that are actually sold in the convenient store, an inventory status, and the like. The discount information may include a discount policy offered from the convenient store or the wholesale supplier. The product information and the discount information may be transferred at desired (or, alternatively predetermined) periods, or may be transferred at an update point in time of information.

In operation S820, the search result provider 720 may provide a search function based on the convenient store DB, and may provide a search result corresponding to a search query to the user terminal 310 in response to receiving the search query from the user terminal 310. The search result provider 720 may provide the search result that is retrieved from the convenient store DB with respect to convenient stores included in a distribution network and at least one of product information and discount information about products actually sold in each convenient store. The search result provider 720 may provide various search criteria and paths, such as a convenient store search function, a product search function, a discount information search function, and the like. For example, in response to the user searching for a specific product, the search result provider 720 may provide a list of convenient stores selling the specific product, an inventory status and discount benefits for each convenient store, and the like, as the search result. Here, the search result provider 720 may provide the search result associated with at least one convenient store specified by the user terminal 310, for example, a convenient store preset by the user, a convenient store frequently used based on a purchase history of the user, and a convenient store present within a predetermined radius from a location of the user terminal 310. As another example, in response to a search request of the user, the search result provider 720 may search for discount products for each convenient store and may provide the search result that includes a list of products corresponding to a discount target and discount contents for each product, for example, price, benefits, and the like. For example, once a convenient store registers a product of which expiration date is approaching as a discount product through the convenient store terminal 301, the search result provider 720 may provide information about the convenient store and the product as a discount product inquiry result.

In operation S830, the product recommender 730 may provide a recommendation function to the user terminal 310 based on the convenient store DB, and may provide recommendation information products available at the convenient store to the user terminal 310.

For example, the product information may include information about a new product newly released or sold. Once information about the new product is updated, the product recommender 730 may provide recommendation information about the new product to the user terminal 310. As another example, once discount information of each convenient store is updated, the product recommender 730 may provide recommendation information about a discount product to the user terminal 310. For example, once a convenient store registers a product of which expiration date is approaching as a discount product through the convenient store terminal 301, the product recommender 730 may push a discount notification of the discount product to the user terminal 310. As another example, if a product desired by the user is absent at a convenient store specified by the user terminal 310 during a search process, the product recommender 730 may provide recommendation information about a product similar to the desired product and/or recommendation information about other adjacent convenient stores having the desired product in stock. Here, the product recommender 730 may provide recommendation information about at least one convenient store specified by the user terminal 310, for example, a convenient store preset by the user, a convenient store frequently used based on a purchase history of the user, and a convenient store present within a predetermined radius from a location of the user terminal 310. Also, the product recommender 730 may provide recommendation information about a product corresponding to a product preference or a purchase pattern through a tag, for example, a product name or type, preset by the user on the user terminal 310 or data analysis associated with the user.

In operation S840, in response to receiving a selection on a specific product from the search result provided through the search function or the recommendation information provided through the recommendation function, the purchase reservation processor 740 may process a purchase reservation of the specific product. For example, the purchase reservation processor 740 may provide a prepayment function capable of making an online purchase reservation with respect to products distributed in a convenient store that is an offline store. Once the product selected by the user is prepaid, the user may request a purchase reservation for the prepaid product. Purchase reservation information corresponding to a purchase reservation request may include user information of the user that requests the purchase reservation, product purchase information about the product that the user desires to purchase, convenient store information about the convenient store that the user is to visit, and time information thereof. The purchase reservation processor 740 may transfer purchase reservation information of the user to the convenient store terminal 301 through the distribution management server 350. The convenient store may verify the prepaid product based on the product purchase information included in the purchase reservation information, and may manage the corresponding product as the prepaid product if the product is in stock and, otherwise, may apply a corresponding status to ordering of the product. For example, the convenient store terminal 301 may verify a current inventory status of the prepaid product based on the product purchase information included in the purchase reservation information and, if the prepaid stoic is out of stock, may generate order information of the product and may transfer the order information to the supplier server 360. Once the out-of-stock prepaid product becomes in stock, the purchase reservation processor 740 may receive product-in-stock information from the convenient store terminal 301 through the supplier server 360 and may transfer a product-in-stock guide to the user terminal 310 of which the user has made the purchase reservation of the product based on the information.

In operation S850, the analyzer 750 may collect user data with respect to products distributed in the convenient store and may analyze a product sales trend. Here, the user data may include a search history, a purchase history, and the like, with respect to products distributed in the convenient store. For example, the analyzer 750 may analyze a product sales trend of the convenient store by analyzing product purchase patterns or product preferences of users with respect to products distributed in the convenient store. Here, the analyzer 750 may cluster user data of users using a corresponding convenient store for each convenient store and may analyze a product sales trend for each convenient store. An analysis result of the product sales trend may be used to determine a product distribution factor within a convenient store distribution network, and may be transferred to the supplier server 360 or may be transferred to the convenient store terminal 301 through the supplier server 360. For example, the wholesale supplier may determine a discount policy, a recommendation product, and the like, in the convenient store distribution network based on the product sales trend that is provided as the analysis result of the user data. The convenient store also may be fed back with the product sales trend as the analysis result of the user data, and may determine an ordering product, order quantity, a discount policy, and the like based on the product sales trend.

Accordingly, the distribution management server 350 may receive the overall information about the convenient store distribution network and may provide a product distribution management service that includes a search portal and an ordering system with respect to the convenient store. Further, the distribution management server 350 may collect user data of users using the corresponding service and may analyze a product sales trend of the convenient store. The distribution management server 350 may feed back the product sales trend that is the analysis result of the user data to the supplier server 360 and/or the convenient store terminal 301, so that the wholesale supplier or the convenient store may apply the product sales trend to determine the product distribution factor.

The apparatuses described herein may be implemented using hardware components, software components, and/or a combination thereof. For example, the apparatuses and components described in the exemplary embodiments may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the exemplary embodiments may be recorded in non-transitory computer-readable media including program instructions to implement various operations embodied by a computer. The media may also include, alone or in combination with the program instructions, data files, data structures, and the like. The media and program instructions may be those specially designed and automatically constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

According to the exemplary embodiments, an automatic product distribution management system and method may provide location information and inventory information of a retailer, such as a convenient store and the like, and may effectively reduce a inventory and waste. Exemplary embodiments may also provide a distribution management system and method that may support a retailer to distribute actual products desired by users. Exemplary embodiments may also provide a distribution management system and method that may provide recommendation information about products based on a product preference, order information, and the like, of a user. Exemplary embodiments may also provide a distribution management system and method that may collect discount information of a retailer and may notify a user of the discount information. Exemplary embodiments may also provide a distribution management system and method that may ensure sales of a retailer in conjunction with a prepayment system and may use analytical data about a purchase of a user for a product distribution.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A computer-implemented automatic product distribution management method comprising:
automatically constructing a database that includes product information and discount information about an actual product sold in each retailer with respect to a distribution network that includes a plurality of retailers; and
providing, to a user terminal, a search result corresponding to a search query in response to the search query received from the user terminal, the search result retrieved from the database with respect to the retailer and at least one of the product information and the discount information.

2. The method of claim 1, wherein the automatically constructing comprises constructing the database by receiving the product information and the discount information from a terminal that is used at each retailer in the distribution network or by receiving the product information and the discount information for each retailer from a supplier server associated with the distribution network.

3. The method of claim 1, wherein the discount information comprises at least one of a discount policy offered from the retailer and a discount policy offered from a wholesale supplier that supplies a product to the retailer.

4. The method of claim 1, wherein the providing comprises providing the search result that includes a list of retailers selling a specific product and at least one of an inventory status and a discount benefit for each of the retailers selling the specific product, in response to the search query being associated with the specific product.

5. The method of claim 1, wherein the providing comprises providing the search result that includes a list of products registered as a discount target for each retailer, in response to the search query being a discount product inquiry request.

6. The method of claim 1, wherein the providing comprises providing the search result that is retrieved within a predetermined radius based on location information of the user terminal, in response to the location information being included in the search query.

7. The method of claim 1, further comprising:
providing, to the user terminal, recommendation information about a product sold in the retailer.

8. The method of claim 7, wherein the providing of the recommendation information comprises providing, to the user terminal, the recommendation information about a product that is updated to the database.

9. The method of claim 7, wherein the providing of the recommendation information comprises providing, to the user terminal, a discount notification of a product corresponding to a discount target in response to the product corresponding to the discount target being registered to the database.

10. The method of claim 7, wherein the providing of the recommendation information comprises determining the recommendation information based on at least one of a product purchase pattern and a product preference of a user of the user terminal.

11. The method of claim 1, further comprising:
processing a purchase reservation of a specific product in response to receiving a selection on the specific product among products sold in the retailer from the user terminal.

12. The method of claim 11, wherein the processing comprises:
providing a prepayment function; and
transferring purchase reservation information about a prepaid product to a retailer specified by the user terminal, in response to processing a prepayment of the selected specific product through the prepayment function.

13. The method of claim 1, further comprising:
collecting at least one user data of a search history and a purchase history associated with products sold in the retailer, and analyzing a product sales trend of the retailer.

14. The method of claim 13, further comprising:
transferring an analysis result of the product sales trend to a terminal that is used at each retailer in the distribution network or a supplier server associated with the distribution network,
wherein the analysis result of the product sales trend is used to determine a product distribution factor in the distribution network.

15. A computer-implemented system for automatic product distribution management, the system comprising:
a memory to which at least one program is loaded; and
at least one processor, wherein the at least one processor is configured with executable instructions to provide:
an information manager configured to automatically construct a database that includes product information and discount information about an actual product sold in each retailer with respect to a distribution network that includes a plurality of retailers; and
a search result provider configured to provide, to a user terminal, a search result corresponding to a search query in response to the search query received from the user terminal, the search result retrieved from the database with respect to the retailer and at least one of the product information and the discount information, and
the information manager is configured to construct the database by receiving the product information and the discount information from a terminal that is used at each retailer in the distribution network or by receiving the product information and the discount information for each retailer from a supplier server associated with the distribution network.

16. The system of claim 15, wherein the at least one processor further comprises:
a product recommender configured to provide, to the user terminal, recommendation information about a product sold in the retailer.

17. The system of claim 16, wherein the product recommender is configured to provide, to the user terminal, a discount notification of a product corresponding to a discount target in response to the product corresponding to the discount target being registered to the database.

18. The system of claim 15, wherein the at least one processor further comprises:
a purchase reservation processor configured to process a purchase reservation of a specific product in response to receiving a selection on the specific product among products sold in the retailer from the user terminal.

19. The system of claim 18, wherein the purchase reservation processor is configured to provide a prepayment function, and to transfer purchase reservation information about a prepaid product to a retailer specified by the user terminal, in response to processing a prepayment of the selected specific product through the prepayment function.

20. The system of claim 15, wherein the at least one processor further comprises:
an analyzer configured to collect at least one user data of a search history and a purchase history associated with products sold in the retailer, and to analyze a product sales trend of the retailer.
